(19) United States
(12) Patent Application Publication
(10) Pub. No.: US 2026/0268716 A1
(43) Pub. Date: Sep. 10, 2026

(54) SHIPPING YARD ENTRY/EXIT VALIDATION SYSTEM AND METHOD

(71) Applicant: Renaissant, Inc., Milwaukee, WI (US)

(72) Inventors: Robert Thomas Dean, Sussex, WI (US); Matthew R. Dean, Stilwell, KS (US)

(73) Assignee: Renaissant, Inc., Milwaukee, WI (US)

(21) Appl. No.: 19/552,982

(22) Filed: Feb. 27, 2026

Related U.S. Application Data
(60) Provisional application No. 63/767,980, filed on Mar. 6, 2025.

(51) Int. Cl. G07C 9/00; G07C 9/25

(52) U.S. Cl. CPC G07C 9/00896; G07C 9/257; G07C 2009/0092

(57) ABSTRACT

A method of operating a shipping yard uses an entry/exit validation system. The entry/exit validation system is configured to provide a token for entry or exit of a truck at the gate of the shipping yard. The token is issued in response to digital driver identification, trailer identification and content identification. The entry/exit validation system is configured to allow entry or exit in response to the token.

### CROSS-REFERENCE TO RELATED APPLICATION

This application claims the benefit of and priority to U.S. Provisional Patent Application No. 63/767980, filed Mar. 6, 2025, the entire disclosure of which are incorporated by reference herein. This application is also related to Canadian Patent Application Serial No. 3228560 and U.S. patent application Ser. No. 18/435,748 filed Feb. 7, 2024, which claim priority to and the benefit of U.S. Provisional Patent Application No. 63/444,473 filed Feb. 9, 2023, the entire disclosures of which are incorporated by reference herein.

### BACKGROUND

The present disclosure relates generally to a shipping yard, warehouse shipping and receiving, and transportation automation system (collectively shipping yard automation system), for example a logistics automation system for transportation nodes such as freight yards, truck yards, port terminals, warehouses, loading docks, etc. In shipping yards, various activities are performed manually and/or tracked on paper, resulting in sub-optimal operations, delays, lack of visibility into operations, and the like. Existing digital solutions are fragmented and provide only isolated solutions for particular aspects of supply chain management.

### SUMMARY

Some implementations of the present disclosure include a method for operating a shipping yard, warehouse shipping and receiving operations, and transportation scheduling. The method includes receiving data in a number of formats from a number of data sources relating to the shipping yard, warehouse, port management systems, and scheduling, standardizing the data from the plurality of formats to a common format, organizing the data in a timeseries, generating operational decisions for the shipping yard by apply artificial intelligence to the timeseries, and causing the shipping yard, warehouse, and transportation to operate in accordance with the operational decisions.

Some implementations of the present disclosure relate to a method of operating a shipping yard where the method includes receiving a truck at a gate of the shipping yard, executing a digital check-in of the truck to the shipping yard, automatically determining a workflow for the truck in response to the digital check-in and using an integrated data structure that that interrelates a warehouse data format used by a warehouse management system and a transportation data format used by a transportation management system, and executing the workflow for the truck using an application surfacing the workflow to shipping yard personnel, wherein executing the workflow comprises moving the truck to a warehouse dock of the shipping yard indicated by the workflow. The workflow can include exit/entry validation.

In some embodiments, executing the workflow for the truck includes staging items for shipment on the truck at a staging area for the warehouse dock indicated by the workflow. In some embodiments, the warehouse data format includes a first hierarchy identifying an order, one or more shipments in the order, and one or more items being delivered in each of the one or more shipments. The transportation data format can include a second hierarchy identifying a trip, a load for the trip, an appointment associated with the trip, and carrier data associated with the appointment. The integrated data structure may provide a link between the load of the transportation data format and the one or more shipments of the warehouse data format. In some embodiments, the integrated data structure can include fields for custom information, hazardous classifications, timing data, entry and exit times, etc.

In some embodiments, the carrier data includes a driver identity, a truck identity, and an asset identity, and executing the digital check-in of the truck to the shipping yard includes automatically validating at least one of the driver identity, the truck identity, or the asset identity. Automatically determining a workflow for the truck can include determining the appointment associated with the validated driver identity, truck identity, or asset identity. Automatically determining a workflow for the truck can include providing automated exception handling in response to a mismatch between the carrier data associated with the appointment and an actual identity of the truck, of a driver of the truck, or of an asset hauled by the truck. Validating at least one of the driver identity, the truck identity, or the asset identity can include collecting, by a camera, an image of the truck and determining an actual truck identity by executing automated image processing of the image of the truck.

In some embodiments, the method includes determining a class of a truck using the automated image processing of the image of the truck and generating an emissions monitoring report based on the validated truck type or truck fuel source and a timestamp associated with the digital check-in of the truck to the shipping yard. In some embodiments, an artificial intelligence engine can be trained to determine the class of truck via camera footage. The camera footage can be associated with a particular site or gate.

In some embodiments, automatically determining the workflow for the truck includes determining an appointment associated with the truck as selected via an appointment scheduling interface and automatically adjusting appointment availability in the appointment scheduling interface based on dynamic monitoring of the shipping yard.

In some embodiments, automatically determining a workflow for the truck using an integrated data structure includes ingesting data from a plurality of sources and translating the data into the integrated data structure. The sources include sources include the warehouse management system, the transportation management system, a port management information system, container status messaging (CSM), a camera system of the shipping yard, and an asset tracking system configured to track movement of equipment in the shipping yard. The method may include storing the data with the integrated data structure in a data lake, wherein automatically determining the workflow for the truck includes accessing the data in the data lake. In some embodiments, near field communication tags can be sued and store data associated with the truck or load.

In some embodiments, executing the workflow for the truck includes controlling movement of automated equipment of the shipping yard in accordance with the workflow. In some embodiments, the method includes automatically determining a workflow for the truck in response to the digital check-in by comparing a check-in time of the digital check-in to an appointment time associated with the truck, adding a first task to the workflow responsive to the appointment time being before the check-in time, and adding a second task to the workflow responsive to the appointment time being after the check-in time.

In some embodiments, the method includes providing an integrated appointment system accessible via an application, a large language model reading electronic messages, or web browser by third-party logistics providers, carriers, customers, vendors, and yard operations personnel. Emails can be processes by an artificial intelligence model to process messages into schedule information. Automatically determining the workflow for the truck can be based on the integrated appointment system, and the method further can include causing shipments to be arranged in staging area based on the integrated appointment system.

In some embodiments, executing the workflow includes causing a forklift to move to a location indicated by the workflow and associated with loading or unloading of the truck. The method can also include tracking locations of trailers in the shipping yard, storing data relating to contents of the trailers in the shipping yard, and causing movement of the trailers in the shipping yard based on routing optimization associated with the contents of the trailers in the shipping yard.

Some implementations of the present disclosure include a shipping yard, wherein the shipping yard includes a gate including at least one of a digital check-in kiosk or a camera, an interface device associated with a shipping yard worker, and an automation platform. The automation platform is programmed to execute a digital check-in of a truck at the gate via the digital check-in kiosk or by executing image processing of an image collected by the camera, automatically determine a workflow for the truck in response to the digital check-in and using an integrated data structure that that interrelates a warehouse data format and a transportation data format, and provide the workflow for the truck to the interface device thereby causing execution of the workflow for the truck, wherein executing the workflow includes moving the truck to a location in the shipping yard indicated by the workflow.

In some embodiments, the warehouse data format includes a first hierarchy identifying an order, one or more shipments in the order, and one or more items being delivered in each of the one or more shipments, the transportation data includes comprises a second hierarchy identifying a trip, a load for the trip, an appointment associated with the trip, and carrier data associated with the appointment, and the integrated data structure provides a link between the load of the transportation data format and the one or more shipments of the warehouse data format.

In some embodiments, the shipping yard includes a data lake configured to store data from a plurality of sources in the integrated data format, wherein the automation platform is communicable with the data lake. In some embodiments, the shipping yard also includes robotic warehouse or shipping yard equipment, wherein the automation platform is further programmed to cause the robotic warehouse or shipping yard equipment to operate in accordance with the workflow for the truck.

Some embodiments relate to a method of operating a shipping yard. The method includes providing a token for entry or exit of a truck at a gate of the shipping yard. The token is issued in response to digital driver identification, trailer identification and content identification. The method includes allowing entry or exit in response to the token. In some embodiments, the token is stored on a near field communication tag, storage on the truck or trailer, and/or storage with the driver.

In some embodiments, the token can be traded to someone else in exchange for a new token. The token is traceable and a chain of custody is tracked in some embodiments. In some embodiments, the token is issued in response a wash history or a content history of a tanker, trailer, or container. The token can also store refrigeration data or temperature data associated with the load.

In some embodiments, a warehouse data format including a first hierarchy identifying an order, one or more shipments in the order, and one or more items being delivered in each of the one or more shipments is used for providing the token. In some embodiments, a transportation data format including a second hierarchy identifying a trip, a load for the trip, an appointment associated with the trip, and carrier data associated with the appointment is used for providing the token. In some embodiments, an integrated data structure is used for providing the token and provides a link between the load of the transportation data format and the one or more shipments of the warehouse data format.

In some embodiments, the carrier data including a driver identity, a truck identity, and an asset identity is used for providing the token and the digital check-in of the truck to the shipping yard is executed by automatically validating at least one of the driver identification, trailer identification and content identification.

In some embodiments, a workflow for the truck including determining the appointment associated with the driver identification, trailer identification and content identification is provided.

In some embodiments, the method also includes automatically determining a workflow for the truck including providing automated exception handling in response to a mismatch between the carrier data associated with the appointment and an actual identity of the truck, of a driver of the truck, or of an asset hauled by the truck.

In some embodiments, the method also includes validating at least one of the driver identity, the truck identity, or the asset identity includes collecting, by a camera, an image of the truck and determining an actual truck identity by executing automated image processing of the image of the truck.

In some embodiments, the method also includes determining a class of the truck using the automated image processing of the image of the truck, and generating an emissions monitoring report based on an emissions classification and a timestamp associated with the digital check-in of the truck to the shipping yard. In some embodiments, the method also includes determining a workflow for the truck including determining an appointment associated with the truck as selected via an appointment scheduling interface. In some embodiments, the method also includes automatically adjusting appointment availability in the appointment scheduling interface based on dynamic monitoring of the shipping yard. In some embodiments, the method also includes automatically determining a workflow for the truck using an integrated data structure including ingesting data from sources and translating the data into the integrated data structure. The sources include a warehouse management system, a transportation management system, a port management information system, a camera system of the shipping yard, and an asset tracking system configured to track movement of equipment in the shipping yard.

In some embodiments, the method also includes storing with the integrated data structure in a data lake. In some embodiments, the method also includes executing a workflow for the truck including controlling movement of automated equipment of the shipping yard in accordance with the workflow. In some embodiments, the method also includes automatically determining a workflow for the truck including comparing a check-in time of the digital check-in to an appointment time associated with the truck, adding a first task to the workflow responsive to the appointment time being before the check-in time, and adding a second task to the workflow responsive to the appointment time being after the check-in time.

In some embodiments, the method also includes providing an integrated appointment system accessible via an application, a large language model reading electronic messages, or web browser by third-party logistics providers, carriers, customers, vendors, and yard operations personnel. In some embodiments, the method also includes executing a workflow comprising causing a forklift to move to a location indicated by the workflow and associated with loading or unloading of the truck. In some embodiments, the method also includes tracking locations of trailers in the shipping yard, storing data relating to contents of the trailers in the shipping yard, and causing movement of the trailers in the shipping yard based on routing optimization associated with the contents of the trailers in the shipping yard.

Some embodiments relate to a shipping yard. The shipping yard includes a gate including at least one of a digital check-in kiosk or a camera, an interface device associated with a shipping yard worker, and an automation platform programmed to provide a token for entry or exit of a truck at the gate of the shipping yard. The token is issued in response to digital driver identification and trailer identification. The automation platform is programmed to provide content identification and allow entry or exit in response to the token.

In some embodiments, the token is issued in response to a wash history or asset history of a tanker, trailer, or container. In some embodiments, the token is issued in response to a content history. In some embodiments, the shipping yard also includes robotic warehouse or shipping yard equipment. The automation platform is further programmed to cause the robotic warehouse or shipping yard equipment to operate in accordance with a workflow for the truck. Automated gate entry systems can be controlled according to data from the token.

Some embodiments relate to an entry/exit validation system is configured to provide a token for entry or exit of a truck at the gate of the shipping yard. The token is issued in response to digital driver identification, trailer identification and/or content identification. The entry/exit system is configured to allow entry or exit in response to the token.

### BRIEF DESCRIPTION OF THE FIGURES

Exemplary embodiments are discussed below with reference to the following drawings wherein like numerals indicate like elements.

FIG. 1 is a block diagram of a shipping yard, warehouse shipping and receiving, and transportation scheduling automation system, according to some embodiments.

FIG. 2 is another block diagram of a shipping yard automation system, according to some embodiments.

FIG. 3 is an illustration of a shipping yard, according to some embodiments.

FIG. 4 is a block diagram of a logistics automation platform, according to some embodiments.

### DETAILED DESCRIPTION

The teachings here relate to an integrated and interoperable logistics workflow platform and to shipping yard and/or port operations using such a platform. The logistics workflow platform (shipping yard automation system, port automation system, etc.) provides an integrated solution for providing workflows and operations throughout a shipping yard or port between one or more gates and one or more docks, including at the gates and at the docks. The workflow can include automated entry/exit validation in some embodiments. The logistics workflow platform can also advantageously be interoperable with other aspects of an entities information technology stack, warehouse management system, security system, fire and safety system, transportation management system, port information management information system, load status, container status messaging, enterprise resource planning system, business intelligence software, and the like. The logistics workflow platform can provide actionable visibility of shipping yard or port operations to guide improved operations in the shipping yard or port, in some embodiments by automatically generating tasks to be executed for efficient shipping yard or port operations. Such tasking and operational visibility can be provided via gate workflows which improve throughput, accuracy, security, and other aspects of gate check-in processes for trucks (or shipments in other transportation modalities) arriving at a shipping yard or port, improve efficient staging and scheduling of warehouse dock workflows, and otherwise provide for management of assets, vehicles, personnel, schedules, etc. within a shipping yard or port. Various technical advantages are achieved by such features and outcomes, for example reduced emissions and fuel consumption based on efficient movement of trucks or other vehicles which reduce engine run-time and the like, increased throughput of goods through the facility, safety, theft prevention and other security advantages, among other improvements provided by the teachings herein, which will become apparent from the following detailed description.

In some embodiments, systems and methods are employed to facilitate entry into or exit out of a yard and ensure proper identification of drivers, loads, certifications (e.g., truck and driver, proper badging, etc.). For example, as a truck enters a yard, the driver, truck and load is monitored for truck identification (e.g., trailer and tractor), driver identification, driver licensing, load identification, capabilities of driver, tractor and/or trailer, requirements of the load, import/export licenses and requirements, proper road usage, etc. Such criteria can be determined from databases and compared to sensed data. If monitored data is proper and corresponds properly to other data, entry of the truck into the yard or exit out of the yard is authorized. In some embodiments, greenhouse credits or carbon dioxide emissions are monitored and tracked at entry and exit. In some embodiments, a machine learning or artificial intelligence model is configured to monitor data associated with the truck, content and driver and issue a token if entry or exit is validated. Validation can be provided in response to ensuring that the correct truck with correct capabilities is with the correct driver with correct capabilities and the correct load at an appropriate time and location.

In some embodiments, requirements for various use cases are checked before entry into the yard or exit from the yard is authenticated or authorized. In some embodiments, a tokenized entry or exit scheme is utilized for authentication. The tokenized entry or exit scheme can have one entry for validated attributes. Other and additional entry authentication schemes besides tokenized entry can be utilized for validated truck driver entry into and/or exit from yards, warehouses and ports. Validations can be based on identity (i.e., actual truck driver identity (e.g., photo identification and face recognition, carrier identification, broker identification, transportation worker identification credential, international credentials, requirements of a type of load, maritime credentials, badges, or asset identification). In some embodiments, validations are with respect to various shipping criteria, (e.g., trailers or containers with certain attributes like temperature capability, previous contents, wash history, weight rating, owner (e.g., container owner), routes taken (e.g., via GPS mapping,) jurisdictional crossings, etc.). The shipping criteria is recorded in a database and can be stored in a block chain format which is readable via an encryption key in some embodiments.

In some embodiments, validation for driver a can occur across different dimensions including but not limited to identification of 1. drivers, carriers, owners, and combinations of drivers, owners, and carriers; and 2. assets (e.g., trailers, trucks, loads, containers, tractors, etc.) In some embodiments, validation for driver entry or exit can require temporal agreement. As an example, a scheduled carrier must match the actual carrier that arrives to pick up or deliver cargo for validation. In some embodiments, the scheduled carrier must match the actual carrier that arrives to pick up or deliver cargo within a particular time window for validation. Carriers can be identified via United States Department of Transportation (USDOT) or Master Carrier (MC) numbers, or markings on their truck (i.e., J.B. Hunt logo, etc.). Scheduled carrier data is received by the system from sources of record—generally the Transportation Management System (TMS), but can also be self-scheduled through the system (i.e., carrier, broker, driver, customer, etc. using a system link to schedule their appointment), through a warehouse management system (WMS), access to a scheduling portal, through large language model reading appointment electronic messages, access to container status messaging, access to a port management information system, or through other system of record. Renaissant, the assignee of the present application, manufactures systems that can be modified for data entry as described herein. The attributes can also be corelated with respect to proper locations (e.g., driver or truck is shown as at the proper location via personal electronic device or vehicle location device).

In some embodiments, carriers or brokers register their drivers in the system (or via a system that the system is connected to) before the driver arrives at the gate. For example, the system validates entry and exit by scanning the driver's commercial driver's license (CDL) or carrier identification (ID) badge (or other identification source) and validates the driver relative to the expected driver (e.g., face recognition, signature, biometric information, cell phone identification). In some embodiments, a database includes a mapping of drivers, to tractors, carriers, brokers, tractors, loads, trailers, etc. and the combination is validated with respect to the actual truck and driver that arrive at the gate. In some embodiments, containers have owners that are distinctly different than carriers. For example, a containers with Maersk on the side are owned Maersk, but the carrier can be JB Hunt. In some embodiments, ocean freight can be booked by the owner of the container, and warehouses or yards use systems and methods to validate that a Maersk container is loaded with certain orders, etc. A non-correlation between driver, truck, broker, or owner can block validation or issuance of the token in some embodiments.

Shipments may require specific types of assets, or conditions of assets. For example, a steel shipment may require a flatbed with a gross vehicular weight rating (GVWR) of 50,000 lbs which can be validated by systems and methods at entry and exit. In another example, food shipments may require a refrigerated trailer (e.g., reefer) with a temperature between 25 degrees F. to 34 degrees F. which can be validated by systems and methods at entry and exit. In some embodiments, food shipments may require a reefer with reefer fuel greater than one half a tank which can be validated by systems and methods at entry and exit.

In another example, a tanker may require a contents history (e.g., gasoline, diesel, sodium chloride, milk, potash, etc.) and/or a wash history (e.g., what wash procedures have been performed after each haul/product change). Some chemicals cannot be put into tankers if they have ever had other types of chemicals in the tanker. Systems and methods can validate such histories at entry and exit with respect to the content in some embodiments. The history is a digital history of tanker contents in some embodiments. The history can provide a digitized wash certificate that maintains all known history with dates, times, pick up and drop off locations (among other data points) of the content history of the tanker (i.e., what has been on it.). In some embodiments, the wash certificate can be maintained for all wash cycles (with the detailed codes, etc. because each wash is different for different cases) for which the tanker has undergone with time stamps, etc. In some embodiments, the digital certificate is presented at a gate for entry or exit to a refinery, chemical plant, etc. ensuring that the tanker is properly granted entrance to pick up a specific type of load or exit to carry a specific type of load. The systems and methods can advantageously ensure that tankers cannot check in for any chemical or food shipments for which it is barred because of the tanker's previous contents or wash cycles using a digital certificate.

In some embodiments, the systems and method use a digital certificate as a ticket that has embedded in the ticket all of the data that a customer wants to validate. In some embodiments, the ticket is a validation ticket for logistics. The ticket includes fields used for validation. The fields include but are not limited to: load number, carrier, required equipment type, broker, appointment time, driver's name, commercial driver's license, transportation worker identification credential, phone number, username, password, driver certifications, drive training record, driver ongoing educational requirements, or any identifying attributes fields. The fields can be utilized for use in two factor authorization techniques. Such techniques can use authenticator applications (e.g., applications that generate one-time passwords that are linked to the current time), biometric data (e.g., fingerprints, facial recognition, or retina scans), verification codes (sent via text message or call) and/or physical or digital tokens and/or badges (e.g., users can use a physical token to generate a passcode).

In some embodiments, the system and methods use a single use ticket that can only be used one time. A centralized system can track the trading of this ticket to see who has it and where it has been forwarded in some embodiments. The system (e.g., port information system, container messaging system, etc.) tracks custody as an advantageous security benefit and provides tokenization (e.g., replacing process that replaces sensitive data with a non-sensitive substitute, or token). In some embodiments, the systems and methods provide a point of sale delivery check point. When a ticket is traded, the initial token is canceled and a new token created. The history of the tokens can be traced to ensure traceability of the chain of custody in some embodiments.

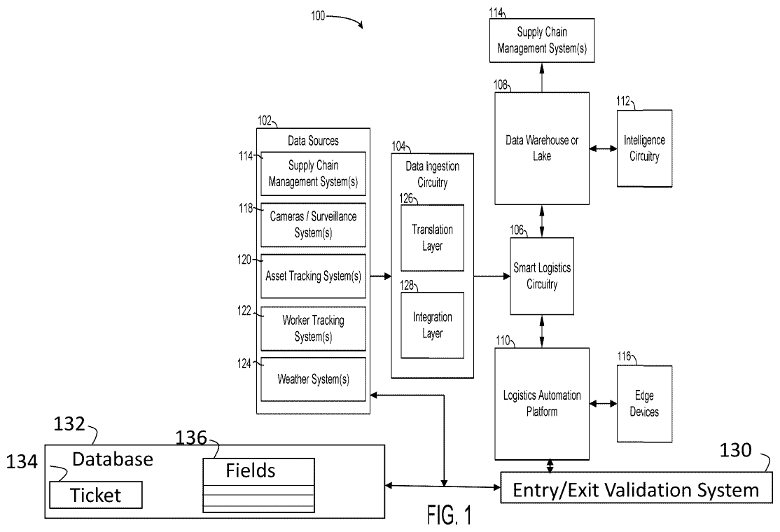

Referring to FIG. 1, a shipping yard, warehouse shipping and receiving, and transportation scheduling automation system 100 is shown, according to some embodiments. The shipping yard automation system 100 can be used to automate processes at transportation nodes such as shipping yards, warehouses, freight yards, intermodal facilities, ports, rail yards, truck yards, loading docks, etc.

A management systems providing entry verification can deployed at shipping yards and can be provided with one or more supply chain management systems, for example, warehouse management systems, transportation management systems, yard management systems, enterprise resource planning systems, etc. and/or separate discrete point solutions such as real-time location systems, camera systems, and sensors. Data collected, generated, and/or otherwise available from such systems can be valuable can be translated from a variety of different data structures, formats, syntaxes, etc. The teachings here provide an integration framework that enables intelligent insights across systems, domains, point solutions, etc. to provide integrated, intelligent shipping yard and logistics process automation and provides entry and/or exit validation in some embodiments.

Other unstructured data from sources not considered by conventional management systems can also be captured and used by systems and processes described herein, in some embodiments. For example, weather data (e.g., historical weather, current weather, weather forecasts) can be used by the systems and processes described herein, in some embodiments, reflecting that weather can significantly affect logistics and shipping yard operations. As another example, data relating to other external events (e.g., major festivals, sporting events, cultural events, route histories, etc.) can be used by the systems and processes described herein, in some embodiments. In some embodiments, dispatch can consider traffic patterns. For example, optimal dispatch at a port can be made depending on the traffic queues at the individual piers. In another example, optimal dispatch at a port can be made depending on the traffic patterns associated with carrier routes.

In some embodiments, the systems and processes described herein collect and use data created by people and devices on the ground in shipping yards (e.g., identifications, histories, certifications, workers, drivers, equipment, cameras, user computing devices, etc.). Such data can be collected via GPS systems, camera systems, various sensors, computing devices used by such people, equipment or vehicles operated by such people, tablets, phones, kiosks, etc. and consolidated with management system data as described in detail below. Such data can include driver check-in data, for example collected via one or more kiosks, web-based interactions (e.g., accessed via a QR code or URL), mobile application operations, pick→pack→ship→loading workflows, or automated check-ins or check outs based on vehicle tracking or detection, dispatch information (e.g., asset number, license plate number, department of transportation number), driver identification/certification, biometric information, or the like.

In some embodiments, patterns can be found through workflow process mining and to find inefficiencies, recommend process improvements, and identify operational and/or business changes to improve yard and logistics operational efficiency. In some embodiments, the systems and processes herein can provide ground level workflows to people on the ground, i.e., people actually working at shipping yards, for example to enable optimal shipping and receiving appointments, autonomous dispatch of yard drivers (e.g., spotting and/or shunting drivers), etc.

These and other features and advantages can be provided by the system 100 of FIG. 1, described in detail in the following passages.

As shown in FIG. 1, the system 100 includes data sources 102, data ingestion circuitry 104 communicable with the data sources 102, smart logistics circuitry 106 communicable with the data ingestion circuitry 104, a data warehouse or lake 108 communicable with the smart logistics circuitry 106, and a logistics automation platform 110 communicable with the smart logistics circuitry 106. The system 100 also includes intelligence circuitry 112 and supply chain management system(s) 114 communicable with data warehouse or lake 108 in some embodiments. In some embodiments, system 100 includes entry/exit validation system 130. The system 100 includes one or more edge devices 116. The system 100 can be implemented in a single location (with components therefore coupled together, implemented on shared hardware, etc.) and/or as distributed system (e.g., with components of the system 100 communicable with one another via a network, via the Internet, via serves, etc.).

Entry/exit validation system 130 is configured for validating entries and/or exits to or from a yard, warehouse, port, etc. System 130 can be a centralized system or be part of edge devices 116 or platform 110 in some embodiments. System 130 can be implemented in a single location (with components therefore coupled together, implemented on shared hardware, etc.) and/or as distributed system (e.g., with components of the system 130 communicable with one another via a network, via the Internet, via serves, etc.).

System 130 can include or be coupled with a database 132. Database 132 can include one or more tickets, such as a ticket 134. Ticket 134 can be for a tractor, trailer, driver or combinations thereof. Ticket 134 can include fields 136. Fields 136 can also be stored separate from ticket 134. System 130 can include alarms and gate actuators at the entrance or exit. Ticket 134 can include histories of assets. Ticket 134 can be a digital token that can be issued to a driver for validated entry or exit. In some embodiments, token 134 serves as a digital validation or approved (e.g., for entry, parking, drop off, pickup, etc.).

The data sources 102 are shown as including one or more supply chain management system(s) 114, one or more camera and/or surveillance systems 118, one or more asset tracking system(s) 120, one or more worker tracking system(s) 122, and one or more weather system(s) 124. Other systems, sensors, devices, user interfaces, etc. can be included in the data sources 102 in various embodiments. Data sources 102 can include biometric information and sensors for driver identification (e.g., biometric sensors, identifications cards, personal electronic devices, cameras, etc.) and information and sensors for tractor, load, content, and trailer identification (e.g., biometric sensors, identifications cards, personal electronic devices, cameras, etc.). Data sources 102 can include tickets, histories, and databases including information for entry/exit verifications. Data sources 102 can include a server or other device for storing fields. The fields include but are not limited to: load number field, carrier field, required equipment type field, broker field, owner field, content field, wash history field, jurisdiction field, trip field, load field, tractor field, trailer field, appointment time field, driver's name field, commercial driver's license field, transportation worker identification credential field, phone number field, user name field, password field, driver certifications field, drive training record field, driver ongoing educational requirements field, or any identifying attributes fields. Fields 136 can be provided in a ticket 134. Data sources 102 are in communication with system 130 and/or database 132 in some embodiments. In some embodiments, data sources 102 are included in system 130 and information from data sources 102 are used to fill ticket 134 and fields 136.

The one or more supply chain management system(s) 114 can include warehouse management systems, transportation management systems, inventory systems, point information management systems, container status messaging systems, order tracking systems, trucking fleet management systems, personnel and human resources management systems, accounting systems, and the like. In various embodiments, the one or more supply chain management system(s) 114 can provide data to the data ingestion circuitry 104 indicating information such as orders to be filled on a given day, assets believed to be present in a shipping yard, deliveries expected to arrive at the shipping yard, and the like. However, as mentioned above, such supply chain management system(s) 114 may handle information about assets entering and leaving shipping yards and include features relating to operations at and within shipping yards. In some embodiments, system 130 is part of or in communication with system 114.

The one or more camera and/or surveillance systems 118 can provide video data, image data, and/or results of processing such video and/or image data to the data ingestion circuitry 104. For example, in some embodiments, the one or more camera and/or surveillance systems 118 can include one or more cameras (e.g., video cameras) or other sensors (e.g., occupancy sensor, motion sensor) or imaging equipment positioned at a shipping yard so as to provide images, video, other data, etc. of movement of people, drivers, vehicles, trailers, tractors, loads, containers, assets, etc. into the shipping yard, out of the shipping yard, and/or within the shipping yard. In some embodiments, the one or more camera and/or surveillance system(s) 118 provide data to the data ingestion circuitry 104 indicating that a person, vehicle, or asset has entered or exited a shipping yard or moved to or from a given position in the shipping yard. Various other related information can also be provided by, or determined based on information from, the one or more camera and/or surveillance system(s) 118. Data ingestion circuitry 104 can provide information to entry/exit validation system 130.

The asset tracking system(s) 120 are configured to track assets and provide data indicative of movement of assets, interactions with assets, and/or other data relating to assets in a shipping yard. In this context, assets can refer to packages, products, goods, trailers, tanks, containers, etc. being handled in a shipping yard for delivery, shipping, receiving, etc. As one example, an asset tracking system 120 can include barcode readers used by workers in a shipping yard to scan labels affixed to assets and/or affixed to fixtures in a shipping yard (e.g., docks, bays, shelves) or vehicles (e.g., forklifts, trucks, ships, etc.) such that sequential scanning of such barcodes provides data indicating that a work is interacting with an asset at that fixture or vehicle and/or that the asset has been moved to or from such a fixture of vehicle. Other hardware for asset tracking (e.g., RFID tags and readers, near-field communication tags and readers, camera systems, smartphones or tables prompting users for direct input, GPS, ultrawide band, or blue tooth low energy (BLE) tags uploading positional data via a network, etc.) can be used in various embodiments of the asset tracking system(s) 120 and entry/exit validation system 130.

The one or more worker tracking system(s) 122 can provide data indicative of worker activity at a shipping yard, for example indicative of workers entering the shipping yard, leaving the shipping yard, and/or moving to various locations with a shipping yard. The worker activity can include driver activity in some embodiments. In some embodiments, a worker tracking system includes a sign-in system (e.g., sign-in kiosk, website, mobile application), time clock, or the like. In some embodiments, the work tracking system includes ID badges worn or carried by the workers (e.g., RFID badges) and scanners or other sensors configured to read the presence of ID badges at different locations and workers move through the shipping yard (e.g., at doors, gates, etc. of a shipping yard). As another example, the one or more worker tracking system(s) 122 may also or alternatively track vehicles or other equipment used by workers, for example forklifts, trucks, cranes, etc. (e.g., using telematics systems of such vehicles). The one or more worker tracking system(s) 122 can thereby provide data indicative of worker activity at a shipping yard to the data ingestion circuitry 104.

The one or more weather system(s) 124 can include a third party weather service (e.g., operated by a governmental authority) that provides historical weather data, data of current weather conditions, and/or weather forecasts (e.g., values of temperature, precipitation, cloud cover, humidity, wind speed, etc. at historical, current, and/or future times). In some embodiments, the one or more weather system(s) 124 include one or more sensors located at a shipping yard and configured to measure weather conditions at the shipping yard (e.g., temperature sensor, humidity sensor, brightness sensor, wind speed sensor, precipitation detector, etc.). Accordingly, the one or more weather system(s) 124 can provide data indicative of historical, current, and/or forecast weather conditions to the data ingestion circuitry 104.

The data sources 102 are thereby configured to provide various data relating to operations at or relating to a shipping yard to the data ingestion circuitry 104. Because of the variety in the data sources 102 (e.g., different types of systems, different technology domains, different vendors, different types of information provided, etc.), it should be appreciated that the data received at the data ingestion circuitry 104 will have multiple different data formats, syntaxes, etc. and may be communicated using different communication protocols, etc. The data may also be asynchronous, i.e., received at different times, indicate activity or conditions at different times, etc. As described in the following passages, the data ingestion circuitry 104 is configured to translate and align incoming data from the data sources 102 to generate a common timeseries of data including information from the data. The time series data can include data for the system 130.

The data ingestion circuitry 104 is shown as including a translation layer 126 and an integration layer 128. The translation layer 126 is configured to translate data from the different data sources 102 into a common format and syntax. The translation layer 126 can operate by using a programmed mapping, for each data source 102, from a format and syntax used by that data source 102 to a common format and syntax used by the data ingestion circuitry 104 and/or can use a machine-learning-based language or data processing tool to provide such mappings. For example, an asset tracking system 120 may represent a location within a shipping yard as “Place A” in the syntax of the asset tracking system 120, while a worker tracking system denotes the same location within the shipping yard as “Location_1.” In such an example, the translation layer 126 can translate both “Place A” and “Location_1” into a common format and syntax (e.g., to “Position-1”) such that asset tracking data and worker tracking data can be directly compared, processed together, handled together, etc. following such translation from the translation layer 126. As another example, dates and/or time stamps in different formats (e.g., month-day-year, yyyy-dd-mm, etc.) can be reformatted into a common format (e.g., yyyy/mm/dd) by the translation layer 126 in some embodiments. Many such examples can be handled by the translation layer 126 in various embodiments. The translation layer 126 can thus be configured to receive data from any source and organize, prioritize, and standardize such data while accelerating throughput. The data can also include history data (e.g., tanker history, etc.) in some embodiments.

The integration layer 128 is configured to integrate the data from the multiple data sources 102 (e.g., as translated by the translation layer 126) into shared, common timeseries data. Timeseries data includes, for each time step for which data is available, a value for each variable, point of information, etc. represented in the timeseries data. For example, a vector or matrix of values can be provided at each time step. The integration layer 128 receives data from the multiple data sources 102 as translated from the data ingestion circuitry 104 and integrates such data into a timeseries.

In some embodiments, the integration layer 128 executes temporal alignment, sampling, and/or interpolation operations to provide full sets of data at each time step of the timeseries. For example, a first data source may provide data on fixed intervals (e.g., weather measurements collected hourly) while a second data source may provide data when an event occurs (e.g., a data point generated when a worker or asset arrives at or leaves a location). Accordingly, raw data may not align in manner directly amenable to combination in a timeseries with data from other data sources.

In some embodiments, the integration layer 128 is configured to establish a frequency of time steps for the timeseries data to be output form the data ingestion circuitry 104 (e.g., every minute, every fifteen minutes, every hour, etc.). For data points provided from the data sources 102 at a higher frequency than the frequency of the timeseries, the integration layer 128 can sample from the higher-frequency data in order to reduce the number values of such data points and provide data aligned with the number and timing of the time steps in the timeseries. For data points provided form the data sources 102 at a lower frequency than the frequency of the timeseries, the integration layer 128 can assign timeseries data directly for some time steps (i.e., non-sequential time steps) and perform interpolation operations to estimate values for such points for intervening time steps. For data provided at irregular frequencies misaligned from the time step intervals of the timeseries, the integration layer 128 can shift such samples in time to the nearest time step and/or perform interpolation operations to estimate values of such data at each time step. Various such operations and programming are contemplated by the present application, as may become useful depending upon the timing, sample rate, etc. of data provided by different data sources 102.

In some embodiments, the integration layer 128 is configured to provide the data with an integrated data structure that is designed to structurally correspond to both a warehouse data structure used by a warehouse management system and a transportation data structure used by a transportation management system. To mirror the warehouse data structure, the integrated data structure can include a hierarchy identifying orders, shipment(s) within each order, and deliveries (e.g., individual items, products, etc.) within each shipment. The data structure can handle any ratio of orders to shipments, including where an entire order ships in one shipment, where multiple orders ship in one shipment, and where one order is divided into multiple shipments (e.g., different items in one order shipped in multiple shipments). To mirror the transportation data structure, the integrated data structure can also include a hierarchy indicating trips, loads within each trip, an appointment associated with each load, a carrier associated with each appointment, and a driver identity, asset (e.g., trailer) identity, content identity, wash history, content history, and/or truck identity associated with the carrier. The integrated data structure can provide an association, link, mapping, etc. between the load data in the transportation-related hierarchy with the shipment data in the warehouse-related hierarchy, so as to provide an integrated data structure which can provide actionable visibility into shipping yard operations and enable yard operations that span warehouse and transportation operations and/or to provide data entry or data exit validation information. For example, the integrated data structure can enable siloed data from various supply chain management system(s) 114 to be interrelated and exposed to ground level users (yard personnel, drivers, etc.) to facilitate yard operations and exit and entry operations, for example via workflow and task generation as described herein.

The data ingestion circuitry 104 is thereby configured to generate, based on data from the multiple data sources 102, timeseries data in a common format, data structure, and syntax that provides information from the multiple data sources 102. By providing such data as an integrated timeseries and/or in an integrated data structure, subsequent processing can operate significantly more efficiently (e.g., faster, with less computing power, etc.) in generating insights based on information from multiple data sources as compared to other approaches, and can enable different (e.g., more advantageous for improving operations) metrics, optimizations, decisions, etc. to be output than could be generated without the availability of such integrated timeseries data or other data in the integrated data structure. FIG. 1 shows the data ingestion circuitry 104 as providing the timeseries data to the smart logistics circuitry 106. The data ingestion circuitry 104 can facilitate routing of data to various applications and/or locations in the data warehouse and/or provide simple, agile, and stable data exchange and transformation, in various embodiments.

The smart logistics circuitry 106 is configured to receive the timeseries data or other integrated data from the data ingestion circuitry 104. The smart logistics circuitry 106 is configured to provide various data routing and processing features for and based on the timeseries data, in various embodiments.

The smart logistics circuitry 106 is configured to cause the timeseries data to be stored in the data warehouse or lake 108. The smart logistics circuitry 106 is configured to receive the timeseries data from the data ingestion circuitry 104 and provided the timeseries data to the data warehouse or lake 108, preserving the translated, integrated timeseries format as provided by the data ingestion circuitry 104. In some embodiments, raw data form the data sources 102 is also provided to the data warehouse or lake 108.

The data warehouse or lake 108 can store the timeseries data and any other data in a data lake, database, etc. in various embodiments. The data warehouse or lake 108 can be provided without data silos and can be infinitely scalable and highly secure while standardizing all data for any use. The data warehouse or lake 108 can provide a data-lake-as-a-service approach for enabling the features herein. The data warehouse or lake 108 can be provided as an enterprise-wide data service for various entities, for example providing a carrier with access to data relating to its multiple customers and those customers multiple shipping yards and other sites, providing a shipping customer with access to data relating to multiple carriers, providing a shipping yard operator with access to data relating to multiple carriers and customers, providing a third party logistics operate with access to data relating to any combination of carriers, customers, sites, entry/exit validation, etc., thereby enabling enterprise-wide insights and coordinated operations. For example, such a data structure can enable access to ground-level truths throughout an enterprise to enable ease-of-service, exception handling, customer relations, etc. while eliminating barriers caused by data silos and manual processes in conventional approaches. Such data can facilitate automated detection handling, bulk commodity delivery payments, enterprise network planning, carrier rankings, and the like. Data base 132 can be provided as part of data warehouse or lake 108.

As shown in FIG. 1, the data warehouse or lake 108 interacts with intelligence circuitry 112. The intelligence circuitry 112 is configured to provide various insights, modeling, learning, key performance indicators, metrics, scores, etc. in various embodiments based on the timeseries data in the data warehouse or lake 108. For example, the intelligence circuitry 112 can apply machine learning techniques (e.g., unsupervised machine learning) to train artificial intelligence models based on the timeseries data in the data warehouse or lake 108 (i.e., based on a timeseries of historical information from the data sources 102). Such artificial intelligence models can be predictive, for example predicting future values or events for later time steps (e.g., rates of shipments, timing of movement of assets or workers, number of deliveries or shipments, backups, delays, etc.) based on timeseries data up to a time step or providing tokens for validated entry and exit. Trained models can be provided from the intelligence circuitry 112 to the smart logistics circuitry 106 for online use for generating recommendations, interventions, actions, operational changes, validations, etc. in various embodiments.

In some embodiments, the intelligence circuitry 112 is configured to calculate durations of time between events represented in the timeseries data. For example, the timeseries data may indicate arrival of a truck at a shipping yard at a first time step, a driver initiating a check-in process at a second time step, the driver completing the check-in process at a third time step, the truck reaching a location in the shipping yard for unloading assets from the truck and/or for loading assets onto the truck at a fourth time step, an indication that the assets were moved (e.g., by a forklift, etc.) within the shipping yard at a fifth time step, and an indication that the truck left the shipping yard at a sixth time step. The intelligence circuitry 112 can assess the durations between any pair of such time steps to determine how long it took for certain actions or groups of actions to occur at the shipping yard. In some embodiments, the intelligence circuitry 112 stores such durations in the data warehouse or lake 108.

In some embodiments, the intelligence circuitry 112 compares the durations for a type of action across instances of the that action (e.g., how long it took for each driver to complete check-in after arrival of the truck at the shipping yard), for example calculating average durations, identifying outliers (e.g., greater than a standard deviation longer or shorter than a mean duration), identifying trends or patterns (e.g., slower check-in times on certain days of the week, for certain trucking companies, for different types of products being delivered/shipped, for different weather, increasing or decreasing average durations over an extended time period, etc.). The integrated, translated timeseries data as provided by the teachings herein enable such durations to be easily and efficiently calculated with respect to any events, conditions, etc. indicated by data from any of the data sources 102.

The intelligence circuitry 112 can provide outputs of such analyses back to the data warehouse or lake 108, for storage in the data warehouse or lake 108 and on-demand access by the smart logistics circuitry 106. In some embodiments, such insights are pre-calculated by the intelligence circuitry 112 and stored in the data warehouse or lake 108 such that the smart logistics circuitry 106 has low-latency access to such insights without needing to wait for calculations to be executed by the intelligence circuitry 112 in response to the smart logistics circuitry 106 requesting such insights. A highly efficient and responsive computing architecture is thereby provided by the teachings herein.

In some embodiments, as shown in FIG. 1, the one or more supply chain management systems 114 are provided access to read data from the data warehouse or lake 108. Such access can enable the one or more supply chain management systems 114 to access (e.g., via an API) the timeseries data stored therein and/or any insights generated by the intelligence circuitry 112 and stored in the data warehouse or lake 108 which can be used by the one or more supply chain management systems 114 to augment the services conventionally provided thereby. The teachings herein thereby enable complementary functionality to be added to or fed into the one or more supply chain management systems 114.

As shown in FIG. 1, the smart logistics circuitry 106 is also configured to automatically generate and provide operating decisions (e.g., recommendations, alerts, actions, commands, schedule changes, settings, etc.) to the logistics automation platform 110 based the current (e.g., most recent) timeseries data from the data ingestion circuitry 104, in some embodiments in combination with previous timeseries data stored in the data warehouse or lake 108. The smart logistics circuitry 106 can receive the current timeseries data as an input, for example using such data as an input to an artificial intelligence model trained by the intelligence circuitry 112 which is configured to generate recommendations, alerts, actions, commands, schedule changes, entry/exit validations, setting etc. relating to operations of the shipping yard. Other programming such as rules-based algorithms, optimization problems, etc. can be executed by the smart logistics circuitry 106 to provide such operating decisions in various embodiments. The smart logistics circuitry 106 can then provide the outputs of such models to the logistics automation platform 110 for implementation.

In some embodiments, the smart logistics circuitry 106 is configured to generate commands and orders to direct yard workers to locations and tasks in the shipping yard. For example, the current timeseries data may indicate the locations of various yard workers and equipment (e.g., forklifts), the locations of assets within the shipping yard, the arrival of particular trucks at the shipping yard, etc. The smart logistics circuitry 106 can then use historical duration information calculated by the intelligence circuitry 112 to generate an optimal schedule for yard workers in order to arrive at desired locations most efficiently to unload and load trucks, for example. For example, based on average durations for check-in time of a truck and movement of the truck to a location in the shipping yard and an average time for the yard worker to move to that location, the smart logistics circuitry 106 can determine when to send the yard worker to that location, optimally select which yard worker to send to that location, etc. Such determinations are then output to the logistics automation platform 110.

Various such scenarios can be considered by the smart logistics circuitry in order to generate ground level workflows to yard works. For example, the smart logistics circuitry 106 can generate outputs associated with automated or streamlined check-in processes, optimized shipping and receiving appointments/schedules, and autonomous dispatches for yard drivers (e.g., spotting or shunting drivers), entry/exit validations, etc. Such intelligence outputs are provided to the logistics automation platform 110.

The logistics automation platform 110 is configured to receive outputs (operating decisions) (e.g., recommendations, settings, actions, schedules, commands, etc.) from the smart logistics circuitry 106 and organize and format such outputs for control of edge devices 116 and/or display at edge devices 116. The edge devices 116 can include personal computing devices of yard workers (e.g., mobile devices, smartphones, barcode readers, tablets, laptops, desktop computers, augmented and/or virtual reality headsets, wearable smart devices, etc.), digital signage, speakers systems (e.g., public address systems), vehicles (e.g., trucks, forklifts), equipment (e.g., doors, gates, cranes, lifts, lights, etc.), among other examples.

For example, the logistics automation platform 110 can host or otherwise provide worker applications accessible to yard workers via edge devices 116 which provides workflow instructions, answers, solutions, etc. to the workers. For example, the logistics automation platform 110 can instruct, based on outputs form the smart logistics circuitry 106, a worker to go to particular location, move a particular asset, operate a particular unit of equipment, display a schedule for the day to the worker, etc. Such instructions can be based on evolving constraints based on other events as represented in the timeseries data. By causing the worker to act in accordance with such instructions, the system 100 thereby automatically affects tangible operations (including exiting and entry operations in some embodiments) of the shipping yard.

As another example, the logistics automation platform 110 can control edge devices 116 based on outputs of the smart logistics circuitry 106, for example opening or closing entrances (e.g., gates, garage doors, loading dock doors, etc.), turning on or off lights, raising or lowering lifts, controlling movement and actions of automated or robotic equipment (e.g., robotic picking machines, driverless vehicles, etc.), etc. Controllable edge devices 116 can thereby be operated automatically in accordance with outputs of the smart logistics circuitry 106, for example in a manner coordinated with instructions provided to workers as discussed above to provide overall operational efficiency in an autonomous manner.

The logistics automation platform 110 can also enable the edge devices 116 to access various insights, tracking information, recommendations, performance indicators, etc. which are enabled and generated by the system 100. For example, the timeseries data from the data ingestion circuitry 104 and stored in the data warehouse or lake 108 can enable shipments to be tracked at the serial-number level (e.g., individual unit, individual package, etc.) both within a shipping yard and through a remainder of a supply chain, and such tracking data can be accessed by an edge device 116. As another example, the edge device 116 can be used by a user to access performance information and/or recommendations about a shipping yard or other aspect of a supply chain, for example indicates that a certain sub-process is slowing down overall shipping yard operations, recommending a reconfiguration of certain procedures or of physical layout of a shipping yard, indicating that one shipping yard is outperforming other shipping yards, indicating total numbers or value of goods moving through the shipping yard, etc. Various valuable insights for monitoring and improving operations can thus be accessible by edge devices 116 via the logistics automation platform 110 in various embodiments.

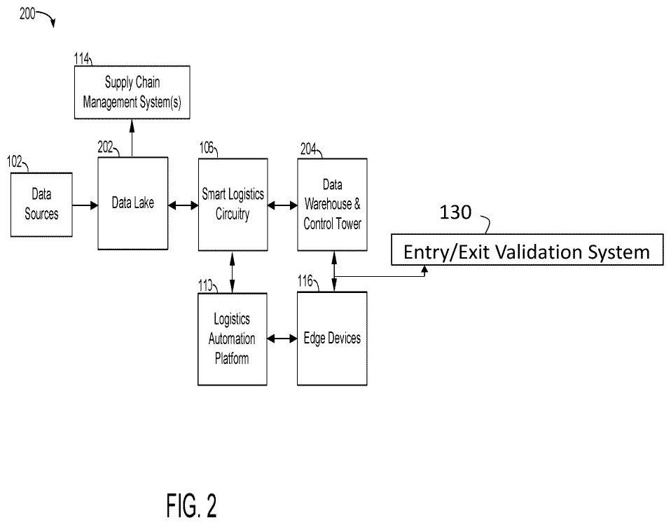

Referring now to FIG. 2, a block diagram of a system 200 is shown, according to some embodiments. The system 200 includes the data sources 102, the smart logistics circuitry 106, the logistics automation platform 110, the supply chain management system(s) 114, and the edge devices 116 as in FIG. 1. The system 200 is also shown as including a data lake 202 and a data warehouse and control tower 204. Entry/exit validation system 130 can be coupled to system 200.

The data lake 202 is configured to receive data from the data sources 102 and store such data in the data lake 202. As described above, the data sources 102 provide data in a variety of formats, syntaxes, data structures, etc.. The data lake 202 is configured to store data in any and all of such formats, syntaxes, data structures, etc. as received from the data sources 102. The data lake 202 thereby provides for diverse data sets to be available together in the data lake 202, rather than siloed into separate systems, databases, files, etc. The data lake 202 serves as a centralized repository for structured and unstructured data from the data sources 102, such that supply chain management data, camera data, surveillance system data, asset tracking data, worker tracking data, weather data, entry/exit data, etc. can all be stored together in the data lake 202. The system 200 can be implemented to provide a data lake as a service for use in shipping yard, warehouse shipping and receiving, and transportation scheduling automation processes and systems.

The smart logistics circuitry 106 as shown in system 200 is configured to enable interoperability between the data lake 202 and a data warehouse and control tower 204. For example, the data warehouse and control tower 204 can store machine learning models or other artificial intelligence models that can operate on data in the data lake 202. For example, the smart logistics circuitry 106 can find data in the data lake 202 and provided it as an input to the machine learning model or other artificial intelligence model of the data warehouse, enabling a scalable and modular approach that operates agnostic of data silos that may exist in other implementations.

In some embodiments, the data warehouse and control tower 204 is configured to provide control tower functionality, for example by generating analytics and dashboards and hosting access to control tower features for a shipping yard, warehouse shipping and receiving, exit/entry validations, and transportation scheduling operations. Control tower features provided by the data warehouse and control tower 204 can leverage data from the data lake 202 in a manner that destroys data silos. Such features can include transformation, processing, visualization and AI/ML automation, including rom ground level high frequency automation (e.g., what goods to pick and when to pick it), all the way up to sales and operations planning, for example planning out optimal numbers of trailers/yard assets or square feet per unit of production. Control tower features can include generating virtual representations of shipping yards, updating such representations in real time, providing schedules, providing controls to edge devices 116, entry/exit validations, and/or logistics automation platform 110, etc. in various embodiments. In some embodiments, the data warehouse and control tower 204 is configured to generate reports that can be used in regulatory filings, for example reports relating to air emissions rules (e.g., pollutant, carbon, etc. emissions of trucks operating at a shipping yard or the like).

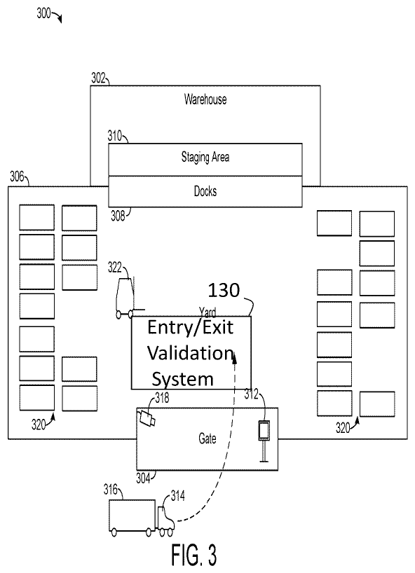

Referring now to FIG. 3, a block diagram of a shipping yard 300 is shown, according to some embodiments. The shipping yard 300 is shown as including a warehouse 302 including a warehouse storage and picking area and a warehouse 302, a gate 304, entry/exit validation system 130, and a yard area 306 (e.g., an outdoor area) between the gate 304 and the warehouse 302. The warehouse 302 includes docks (doors, etc.) 308 providing access to the warehouse 302 from the yard area 306 and a staging area 310 for staging shipments to be loaded out to assets in the yard area 306 via the docks 308 and/or for receiving items from assets in the yard area 306 via the docks 308. The shipping yard automation system 100, system 130, the system 200, and/or components thereof (e.g., logistics automation platform 110, smart logistics circuitry 106) can be deployed for the shipping yard 300 to manage and affect operations throughout the shipping yard 300, including workflow at the gate 304, within the yard area 306, and at the docks 308 and staging area 310. Workflow at gate 304 includes entry/exit validations in some embodiments.

The gate 304 is shown as including devices for digital check-in of trucks (or other vehicles) arriving at the shipping yard 300. As shown, the digital check-in devices including a kiosk 312, for example including a touch-screen interface for user interaction with the kiosk 312 via a graphical user interface. The graphical user interface on the kiosk 312 can prompt a user for, and collect, information relating to the truck arriving at the shipping yard 300 (e.g., truck 314, an asset (e.g., trailer 316) arriving with the truck, the driver of the truck (e.g., commercial driver's license data, etc.), an appointment associated with the trip and/or load of the truck, etc. The kiosk 312 can be operated as an edge device 116 as shown in FIGS. 1-2 as controlled by and/or otherwise interoperable with the logistics automation platform 110 to collect and provide information relating to a digital check-in workflow for the shipping yard 300 and to provide instructions and/or other tasking or workflow information to the truck 314 (e.g., to its driver) for proceeding into the yard area 306. For example, the kiosk 312 may instruct the user to move to a particular dock of the docks 308, to a particular staging or waiting area within the yard area 306, etc., for example as may be automatically determined according to the teachings herein.

The digital check-in device of the gate 304 can alternatively or additionally include a camera 318 (e.g., included with cameras/surveillance system(s) 118 of FIG. 1). The camera 318 is configured to collect one or more images of the truck 314 and trailer 316 (or other vehicle and asset) entering the gate 304. Data from the camera 318 can be processed using an image processing technique (machine vision, computer vision, character recognition, machine-learnt classifier, etc.) to detect an information relating to the truck 314, trailer 316, and/or driver. For example, the images from the camera 318 can be used to read license plate information of the truck 314 and/or trailer 316, to read carrier information (e.g., carrier name), a vehicle identification number, etc. from information printed on an exterior of the truck 314 and/or trailer 316, detect a class of the vehicle (e.g., determine a truck type, size, fuel type, etc.) and/or other information which may be sufficient for executing digital check-in of the truck 314 to the shipping yard 300 and/or useable for other monitoring and reporting of shipping yard operations.

As illustrated in FIG. 3, the kiosk 312 in the yard area includes various assets 320, for example trailers, flatbeds, etc. awaiting unloading at the docks 308 and/or awaiting retrieval from the yard area 306 by a truck for transportation to a destination. The yard management or transportation scheduling automation system 100 described herein can advantageously monitor the location of such assets 320 in the yard as well as the order, shipment, delivery/item data associated with such assets and loads in the integrated data structure described above. As such, the integrated data structure can be used to enable management and optimization of asset locations within the yard as well as optimal staging of such assets for loading or unloading via docks 308 and for retrieval by trucks for removal from the yard area 306 via gate 304. As shown, a forklift 322 or other yard equipment can be included (e.g., as or including an edge device 116) and operable in accordance with tasking and workflows generated by the yard management system or transportation scheduling automation system 100 and/or component thereof for moving, rearranging, affecting flow of, etc. assets 320 through and around the yard area 306. An integrated workflow platform enabling efficient operation of the shipping yard 300 can be provided by the teachings herein.

In some embodiments, entry/exit validation system 130 is configure dot allow entry or exit based upon schedule, driver identification, content identification, trailer identification, histories. For example, correspondence between driver licenses and abilities is required for entry or exit. In some embodiments, tanker content history/wash history must correspond to requirements for the content about to be loaded. In some embodiments, temperature history on the trailer must correspond to requirements for the content carried by the trailer. In some embodiments, route history correspondence to expected previous routes is required for validation. In some embodiments, driver identification is checked with live data (e.g., biometric information or two factor authorization) to issue ticket 134 or a token. In some embodiments, the validation is provided in the form of a ticket (e.g., ticket 134 or token issued by system 120). In some embodiments, ticket 134 is separate from fields 136 in database 132. Other criteria or data and combination of data can be checked for token issuance in some embodiments. In some embodiments, a token can be issued to the driver for entry or exit upon requirement checks using data in fields 136 as described above. In some embodiments, fields 136 store wash history, wash cycles, content histories, etc. as a digital history and are used with the intended pickup content to provide a validation (e.g., ticket) that indicates whether the intended pickup content can be loaded. The validation can ensure safety of a tanker and/or content. Entry/exit validation system 130 can use such data to approve the intended pickup of the content.

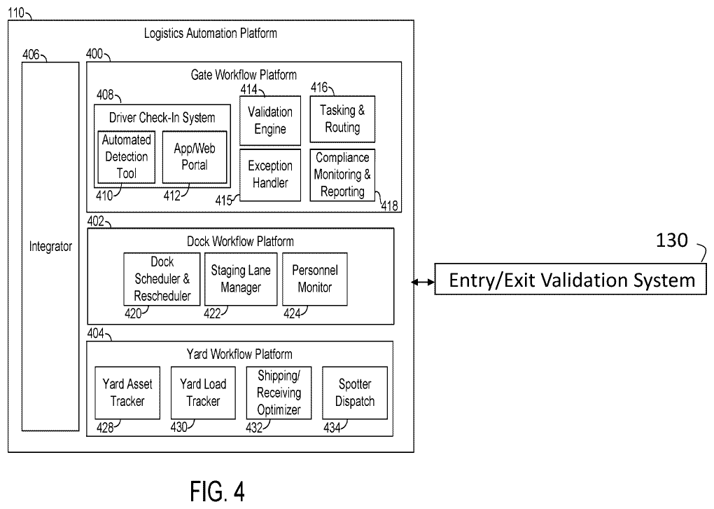

Referring now to FIG. 4, a detailed block diagram of the logistics automation platform 110 is shown, according to various embodiments. Platform 110 can be include or be in communication with entry/exit validation system 130. The various elements of the logistics automation platform 110 and entry/exit validation system 130 can be implemented as one or more processors and one or more computer-readable storing program instructions that, when executed by the one or more processors, cause the one or more processors to perform the operations attribute to the logistics automation platform 110 and its components herein. Any combination of implementation of such programming and processing on remote or distributed computing resources (e.g., cloud platform) or local or dedicated hardware (e.g., local server(s)) to provide the operations disclosed herein is within the scope of the present disclosure.

The logistics automation platform 110 is shown as including a gate workflow platform 400, a dock workflow platform 402, a yard workflow platform 404, and an integrator 406 for providing integrations and interoperability between the gate workflow platform 400, the dock workflow platform 402, and the yard workflow platform 404. Accordingly, the logistics automation platform 110 can provide integration workflow platforms for operations throughout a shipping yard, from the gate to warehouse docks and staging areas and various locations and equipment in between. The logistics automation platform 110 and the various components thereof can operate using data from and/or store data to the data warehouse or lake 108 and leverage artificial intelligence or other operations of the smart logistics circuitry 106 to support operations described herein, in various embodiments.

The gate workflow platform 400 is configured to provide one or more workflows relating to operations at a gate (entrance, exit, etc.) of a shipping yard. The work flows can be used in a truck parking yard to approve a user, carrier, content, etc., for parking in the yard for a period of time. Gate workflow platform can track the stay in the parking yard. As shown in FIG. 4, the gate workflow platform 400 includes a driver check-in system 408. The driver check-in system 408 can provide for driver check-in using one or more modalities which can be selectively deployed in various implementations. As shown, the driver check-in system includes an automated detection tool 410 and an app or web portal 412. The automated detection tool 410 is configured to automatically detect identifying data of a truck arriving at a gate, of a driver of the truck, of a trailer or other asset being transported by the truck, etc., for example via image processing (e.g., character recognition, facial recognition, machine classification, etc.) of images collected by camera 318 and/or cameras/surveillance system(s) 118. The automated detection tool 410 can use other data sources in other embodiments (e.g., reading an RFID tag or other wireless identifier of a truck arriving at the gate, etc.). The app or web portal 412 can provide a graphical user interface accessible via an end user device of a driver (e.g., smartphone, tablet, etc.), for example accessible by a driver by scanning a QR-code, barcode, near-field-communication chip, or other information source accessible to the end user device. The app or web portal 412 can provide a graphical user interface which prompts the driver to input data relating to an identity of the truck, an identity of a carrier (e.g., USDOT identification, motor carrier number), the driver's identity, an asset identity, etc. and/or to select an appointment associated with the trip being executed by the driver. The driver check-in system 408 can determine an appointment associated with the arriving trip, truck, asset, load, carrier, driver, etc. and initiate further processes of the gate workflow platform 400 in response to driver check-in.

The gate workflow platform 400 is shown as including a validation engine 414 which can execute validation operations in response to driver check-in via the driver check-in system 408. The validation engine 414 can operate to validate that the driver, truck, asset, etc. checked-in via the driver check-in system 408 matches data from a scheduled appointment and or data obtained from a transportation management system, for example using data in an integrated data structure as described above. Such validation can confirm that the driver, truck, etc. is expected at the shipping yard and is associated with legitimate logistics operations involving the shipping yard (e.g., as opposed to being an effort at theft). In response to successful validation that a driver check-in matches a scheduled appointment, further yard operations and workflows can be provided, as described below. In some embodiments, the validation engine 414 also collects and validates data including vehicle temperature, fuel level, weight (e.g., via a scale for in and out weights at the gate area), and/or other values which can ensure accurate shipping and receiving to and from the shipping yard. Validation engine 414 can be part of system 130.

The gate workflow platform is also shown as including an exception handler 415. For example, if the validated data at driver check-in does not match expected driver, truck, asset, or other data relating to a scheduled appointment or other trip data as indicated by a transportation management system, the exception handler 415 can provide one or more interventions for enabling continued yard operations. In some scenarios, the exception handler 415 can schedule a new appointment associated with an unexpected arrival, can adjust a scheduled based on an early arrival or a late arrival, or can otherwise adjust gate, yard, and dock workflows based on failed validation of driver check-in and/or other mismatch between driver check-in and an appointment schedule or other data from a management system as to expected yard arrivals. In some embodiments, validation engine provides tokens as described above after checks of the various fields 136 or other data discussed above. In some scenarios, the exception handler 415 can determine that a check-in which fails to be validated corresponds to suspected criminal activity (e.g., an attempt to gain unauthorized access to the shipping yard for theft, vandalism, or other illicit purposes) and can contact law enforcement, close the gate, or take other intervening action. Various intelligent and adaptive exception handling operations can be executed in various scenarios by the exception handler 415, for example responsive to detecting that a load was already picked up, that no appointment was scheduled, that an appointment was missed, that the wrong or non-compliant equipment (e.g., truck type, asset type, etc.) is provided, or that any other exception to proper or expected operations is occurring.

The gate workflow platform 400 is also shown as including tasking and routing 416. Tasking and routing 416 of the gate workflow platform 400 can be executed to provide tasks to be executed by the truck responsive to arrival at the gate and/or a route for the truck to follow upon entering the shipping yard via the gate. Tasking and routing 416 can include generating a workflow of tasks to be completed by multiple people, equipment, etc. within the shipping yard, for example one or more tasks to be completed by a driver of the truck, by personnel in the shipping yard, by a robotic picker in the warehouse, by personnel at the warehouse docks, by a door of the warehouse, etc., including, in some embodiments, times at which such tasks should be completed. Tasking and routing 416 can include automatically determining, by the gate workflow platform 400 interoperating with the dock workflow platform and the yard workflow platform 404 as described below, an optimal location or set of locations for a truck to take to move through the shipping yard. For example, the gate workflow platform 400 can generate instructions for a driver as to a path to take to a particular dock or other location in a shipping yard and a timing for taking such path. The tasking and routing 416 provided in the gate workflow platform 400 can thereby initiate, in response to driver check-in (and based on validation and/or exception handling associated with such check-in) a workflow for the truck entering the gate in coordination with the dock workflow platform 402 and the yard workflow platform 404.

As shown in FIG. 4, the gate workflow platform 400 also includes compliance monitoring and reporting 418. Via compliance monitoring and reporting 418, the gate workflow platform 400 is configured to monitor compliance with one or more regulatory requirements, enterprise goals, industry standards, or other goals, targets, or limits. For example, one such compliance limit or goal may relate to emissions from vehicles entering and leaving the gate. Compliance monitoring and reporting 418 can include tracking the types of vehicles and number of vehicles entering and leaving the gate, for example via machine vision applied to camera images of such vehicles in the gate area (e.g., a machine-learnt classifier trained to distinguish vehicle types) and exit/entry validations. Timing data can be collected, for example time of day for each vehicle entering and leaving the gate, duration data relating to duration of driver check-in, queueing times, duration of time a truck spent in the shipping yard, etc. Compliance monitoring and reporting 418 can then generate a report (dashboard, user interface, data set, form consistent with government submission requirements, etc.) relating to such data, for example relating to emissions estimates relating to the shipping yard based on such data. In some embodiments, the gate workflow platform 400 is programmed to generate recommendations for workflow adjustments to improve a metric associated with compliance monitoring and reporting, for example optimizing tasking and routing 416 based on one or more objectives monitored by compliance monitoring and reporting 418.

The dock workflow platform 402 is configured to interoperate with the gate workflow platform via integrator 406 (which may be provided as a common data bus, programming interface, or other architecture for enabling integrations and interoperations both between the components of the logistics automation platform and with outside systems). The dock workflow platform 402 is configured to manage and cause execution of workflows for warehouse docks (e.g., docks 308) as well as staging areas within a warehouse (e.g., staging area 310) and/or other spaces, equipment, etc. for managing the shipments and loads which are provided at docks for loading on to trucks and/or which are unloaded from trucks at docks.

As shown in FIG. 4, the dock workflow platform 402 includes dock scheduler and rescheduler 420. The dock scheduler and rescheduler 420 is configured to provide and dynamically adjust an appointment schedule for warehouse docks. In some embodiments, the dock scheduler and rescheduler 420 provides a scheduling interface showing dock availability to multiple stakeholders, including drivers, carriers, shipping yard personnel, end customers, distributors, etc. to enable appointment scheduling and rescheduling by any relevant persons via a shared scheduling interface (e.g., as opposed to scheduling from individuals which may otherwise occur via siloed management systems for different types of users and which may therefore often have inaccurate or out-of-date appointment availability information). A common appointment schedule, including availability for new appointments, can be maintained by the dock scheduler and rescheduler 420 for access by users of different roles, providing a ground truth, accurate, up-to-date schedule for docks of the shipping yard.

The dock scheduler and rescheduler 420 can also provide for automated scheduling and rescheduling, in some embodiments. Responsive to a driver check-in, the dock scheduler and rescheduler 420 can interoperate with the gate workflow platform 400 to determine if a truck is on-time, early, or late for an appointment in a dock schedule. If the truck is early or late for the appointment, the appointment schedule can be dynamically adjusted by the dock scheduler and rescheduler 420, for example to prevent further delays associated with a late truck, to expedite loading or unloading of an early truck, to adjust surrounding appointments to avoid propagation of delays or missed time associated with early or late arrival, etc. In some embodiments, the dock scheduler and rescheduler 420 can automatically reschedule an appointment based on predicting early or late arrival, for example based on truck location data, weather data, and/or traffic data. A dynamic dock schedule accessible by various types of users involved in shipping yard operations can thereby be provided by the dock scheduler and rescheduler 420.

The dock workflow platform 402 is also shown as including a staging lane manager 422. The staging lane manager 422 can manage workflows and tasking for staging of shipments in a warehouse to be added as loads onto trucks, for example based on a schedule maintained by the dock scheduler and rescheduler 420. The staging lane manager 422 can leverage the integrated data structure described above to seamlessly associate orders, shipments, and items being picked from a warehouse (e.g., based on a warehouse management system for internal warehouse operations) with appointments for different docks, doors, etc. of the warehouse and trucks, assets, carriers, drivers, third-party logistics providers, vendors, etc. associate with such appoints. The staging lane manager 422 can thereby provide, in a natively integrated manner, for arrangement of shipments to be provided as loads onto associated trailers, trucks, etc., for example based on associations of shipments and loads across the integrated data structure described above. The staging lane manager 422 can cooperate with the tasking and routing 416 to coordinate routing of a truck to a warehouse dock associated with a staging lane which the staging lane manager 422 allocated to shipments to be provided to the truck as a load for the trucks next trip. The staging lane manager 422, in coordinated operations with the gate workflow platform 400, can thereby cause trucks to arrive at associated gates for which shipments have already been prepared for loading onto such trucks, for example in an optimal manner which minimizes idle times, loading times, unloading times, etc., in various embodiments.

The dock workflow platform 402 is also shown as including a personnel monitor 424. The personnel monitor 424 can track the locations, availability, workload, identity, etc. of personnel operating in the dock area. The personnel monitor 424 can provide personnel availability data for use by the dock scheduler and rescheduler 420 to ensure that suitable personnel is available at the dock to complete scheduled appointments (e.g., to assist with loading and unloading). The personnel monitor 424 can also automatically detect any unauthorized persons in the dock area, for example to trigger a theft warning or alarm. In some embodiments, the personnel monitor 424 can provide, for example via a mobile application or computer interface, instructions to personnel as to the docks to be served by different personnel, shipments to stage as loads in different lanes of a staging area, equipment (e.g., forklifts) to prepare for use in upcoming appointments, etc. The personnel monitor 424 can thereby provide the dock workflow platform 402 with visibility into the staffing availability at the docks and the warehouse.

The logistics automation platform 110 is also shown as including a yard workflow platform 404. The yard workflow platform 404 is configured to generate and coordinate workflows through the shipping yard, for example focused on an area between the gate and the docks. The yard workflow platform 404 can treat the yard as an extension of the warehouse while also providing native interoperation with transportation-side systems, for example by using the integrated data structured provided herein which represents warehouse shipments and truck loads in a unified manner. The yard workflow platform 404 can interoperate with the gate workflow platform 400 and the dock workflow platform 402 to provide coordinated workflows through the shipping yard.

As shown in FIG. 4, the yard workflow platform 404 includes yard asset tracker 428. The yard asset tracker 428 is configured to track the locations of assets in the yard, for example assets 320 in the yard area 306 in the example of FIG. 3. The yard asset tracker 428 can use data from camera systems, surveillance systems, user device inputs, etc. to keep an up-to-date representation of the location of assets (e.g., tanks, trailer, containers, etc.) in the yard. For example, the yard asset tracker 428 may provide a digital twin of the shipping yard and the assets therein.

The yard workflow platform 404 is also includes a yard load tracker 430. The yard load tracker 430 maintains an inventory of the load included on the assets in the shipping yard, and, in some scenarios, shipments associated with such loads, for example using the integrated data structure described herein. By maintaining visibility of the load associated with each asset in the shipping yard, and the location of each asset in the shipping yard, the yard workflow platform 404 maintains actionable visibility into the arrangement of loads, shipments, etc. as arranged in the shipping yard between the gate and the docks.

The yard workflow platform 404 is also shown as including a shipping/receiving optimizer 432. The shipping/receiving optimizer 432 can perform one or more optimizations (e.g., analytical optimization of an objective function relating to shipping yard throughput, an AI-based optimization approach, etc.) for determining tasks to be performed in the shipping yard and for routing trucks, assets, etc. through the shipping yard. For example, the yard workflow platform 404 may leverage load and asset data from the yard asset tracker 428 and the yard load tracker 430 to prioritize unloading of assets including loads which include out-of-stock items or low-stock items, such that corresponding assets are unloaded before assets with loads including high-stock items. The shipping/receiving optimizer 432 can also thereby cause rearrangement of empty assets for optimal loading and/or loaded assets for optimal connection to a truck for removal from the shipping yard. The shipping/receiving optimizer 432 can cooperate with the tasking and routing 416 of the gate workflow platform 400 and the dock scheduler and rescheduler 420 of the dock workflow platform to coordinate tasks at the gate, through the shipping yard, and to the dock, and from the dock to the gate after loading and/or unloading.

The yard workflow platform 404 is also shown as including spotter dispatch 434. The spotter dispatch 434 can generate tasks for spotters, for example based on outputs of the shipping/receiving optimizer 432, and provide such tasks to spotters via edge devices (e.g., user personal computing devices, interfaces of forklifts or other equipment, etc.) and/or automatically control robotic yard equipment to execute such tasks. Tasks can include moving assets in the yard between locations and/or otherwise preparing assets and loads for loading and/or unloading, as well as the time at which such tasks are to be executed. Moving of assets and other tasks within are yard are thereby executed in accordance with workflows, tasks, schedules, etc. generated by the logistics automation platform 110.

The hardware and data processing components (e.g., “circuitry”) used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

What is claimed is:

1. A method of operating a shipping yard, comprising:
providing a token for entry or exit of a truck at a gate of the shipping yard, wherein the token is issued in response to digital driver identification, trailer identification and content identification;
allowing the entry or exit in response to the token.

2. The method of claim 1, wherein the token is issued in response a wash history or a content history.

3. The method of claim 1, wherein:
a warehouse data format comprising a first hierarchy identifying an order, one or more shipments in the order, and one or more items being delivered in each of the one or more shipments is used for providing the token;
a transportation data format comprising a second hierarchy identifying a trip, a load for the trip, an appointment associated with the trip, and carrier data associated with the appointment is used for providing the token; and
an integrated data structure is used for providing the token and provides a link between the load of the transportation data format and the one or more shipments of the warehouse data format.

4. The method of claim 3, wherein the carrier data comprising a driver identity, a truck identity, and an asset identity, is used for providing the token and wherein digital check-in of the truck to the shipping yard is executed by automatically validating at least one of the driver identification, trailer identification and content identification.

5. The method of claim 4, wherein a workflow for the truck comprising determining the appointment associated with the driver identification, trailer identification and content identification is provided.

6. The method of claim 4, wherein automatically determining a workflow for the truck comprises providing automated exception handling in response to a mismatch between the carrier data associated with the appointment and an actual identity of the truck, of a driver of the truck, or of an asset hauled by the truck.

7. The method of claim 4, wherein validating at least one of the driver identity, the truck identity, or the asset identity comprises collecting, by a camera, an image of the truck and determining an actual truck identity by executing automated image processing of the image of the truck.

8. The method of claim 7, further comprising:
determining a class of the truck using the automated image processing of the image of the truck; and
generating an emissions monitoring report based on a validated truck type and a timestamp associated with the digital check-in of the truck to the shipping yard.

9. The method of claim 1 further comprising determining a workflow for the truck comprises determining an appointment associated with the truck as selected via an appointment scheduling interface;
wherein the method further comprises automatically adjusting appointment availability in the appointment scheduling interface based on dynamic monitoring of the shipping yard.

10. The method of claim 1, further comprising:
automatically determining a workflow for the truck using an integrated data structure comprising ingesting data from a plurality of sources and translating the data into the integrated data structure, wherein the plurality of sources comprise a warehouse management system, a transportation management system, a camera system of the shipping yard, and an asset tracking system configured to track movement of equipment in the shipping yard.

11. The method of claim 8, further comprising storing with the integrated data structure in a data lake.

12. The method of claim 1, further comprising executing a workflow for the truck comprising controlling movement of automated equipment of the shipping yard in accordance with the workflow.

13. The method of claim 1, further comprising:
automatically determining a workflow for the truck comprising:
comparing a check-in time of digital check-in to an appointment time associated with the truck;
adding a first task to the workflow responsive to the appointment time being before the check-in time; and
adding a second task to the workflow responsive to the appointment time being after the check-in time.

14. The method of claim 1, further comprising providing an integrated appointment system accessible via an application or web browser by third-party logistics providers, carriers, customers, vendors, and yard operations personnel.

15. The method of claim 1, further comprising executing a workflow comprising causing a forklift to move to a location indicated by the workflow and associated with loading or unloading of the truck.

16. The method of claim 1, further comprising tracking locations of trailers in the shipping yard, storing data relating to contents of trailers in the shipping yard, and causing movement of the trailers in the shipping yard based on routing optimization associated with the contents of the trailers in the shipping yard.

17. A shipping yard, comprising:
a gate comprising at least one of a digital check-in kiosk or a camera;
an interface device associated with a shipping yard worker; and
an automation platform programmed to:
provide a token for entry or exit of a truck at the gate of the shipping yard, wherein the token is issued in response to digital driver identification, trailer identification and content identification; and
allow the entry or exit in response to the token.

18. The shipping yard of claim 17, wherein the token is issued in response to a wash history.

19. The shipping yard of claim 17, wherein the token is issued in response to a content history.

20. The shipping yard of claim 17, further comprising robotic warehouse or shipping yard equipment, wherein the automation platform is further programmed to cause the robotic warehouse or shipping yard equipment to operate in accordance with a workflow for the truck.
